(19) United States
(12) Patent Application Publication
(10) Pub. No.: US 2014/0155507 A1
(43) Pub. Date: Jun. 5, 2014

(54) RESIN FOAM AND PROCESS FOR PRODUCING THE SAME

(71) Applicants: Mitsuhiro Kanada, Ibaraki-shi (JP); Mie OTA, Ibaraki-shi (JP); Yoshinori Kouno, Ibaraki-shi (JP); Hironori Yasuda, Ibaraki-shi (JP); Yuko Kandori, Ibaraki-shi (JP)

(72) Inventors: Mitsuhiro Kanada, Ibaraki-shi (JP); Mie OTA, Ibaraki-shi (JP); Yoshinori Kouno, Ibaraki-shi (JP); Hironori Yasuda, Ibaraki-shi (JP); Yuko Kandori, Ibaraki-shi (JP)

(73) Assignee: NITTO DENKO CORPORATION, Ibaraki-shi, Osaka (JP)

(21) Appl. No.: 14/236,749

(22) PCT Filed: Jul. 24, 2012
(86) PCT No.: PCT/JP2012/068679

§ 371 Date: Feb. 3, 2014

(30) Foreign Application Priority Data
Aug. 2, 2011 (JP) 2011-169624
Aug. 2, 2011 (JP) 2011-169625
Jul. 20, 2012 (JP) 2012-161059

(51) Int. Cl. C08L 33/08; C08J 9/00

(52) U.S. Cl. CPC C08L 33/08; C08J 9/00
USPC 521/138; 264/413

(57) ABSTRACT

Provided is a resin foam that is satisfactorily flexible and highly resistant to heat, exhibits superior strain recoverability at high temperatures, and has a high instantaneous recovery rate. This resin foam is formed from a resin composition containing an acrylic polymer, an active-energy-ray-curable compound having two (meth)acryloyl groups per molecule, an active-energy-ray-curable compound having three or more (meth)acryloyl groups per molecule, and a thermal crosslinking agent. The active-energy-ray-curable compound having two (meth)acryloyl groups per molecule and the active-energy-ray-curable compound having three or more (meth)acryloyl groups per molecule are preferably contained in a total content of from 20 to 150 parts by weight per 100 parts by weight of the acrylic polymer.

### TECHNICAL FIELD

The present invention generally relates to resin foams and production processes therefor. Specifically, the present invention relates to a resin foam and a production process therefor, which resin foam is useful typically for or as internal insulators in electronic appliances and other articles, cushioning materials, sound insulators, heat insulators, food packaging materials, clothing materials, and building materials.

### BACKGROUND ART

Some foams have been used for or as internal insulators in electronic appliances and other articles, cushioning materials, sound insulators, heat insulators, food packaging materials, clothing materials, and building materials. These foams should be flexible and excel in properties such as cushioning properties and heat insulating properties so as to provide good sealability upon assemblage as components. Among foams, thermoplastic resin foams typified by foams of polyolefins such as polyethylenes and polypropylenes are well known. These foams, however, disadvantageously have low strengths and are insufficient in flexibility and cushioning properties. In particular, when compressed and held in the compressed state at high temperatures, they disadvantageously exhibit poor strain recover, resulting in inferior sealability. An attempt to improve such poor strain recoverability has been made by incorporating, for example, a rubber component into a material resin to impart elasticity thereto. This allows the material resin itself to become flexible and to exhibit restitution due to the elasticity so as to provide better strain recoverability. The resulting foam, however, exhibits a low expansion ratio although generally having better restitution by the action of elasticity of the incorporated rubber component. This is because, once the resin undergoes expansion and deformation by the action of a blowing agent to form a cell structure in a foam production process, the cell structure thereafter contracts due to the restitutive force (resilience) of the resin.

Customary processes for the production of foams are generally exemplified by chemical processes and physical processes. A common physical process involves dispersing a low-boiling liquid (blowing agent), such as a chlorofluorocarbon or a hydrocarbon, in a polymer and then heating the dispersion to volatilize the blowing agent to thereby form cells (bubbles). A chemical process involves adding a compound (blowing agent) to a polymer base, thermally decomposing the compound to evolve a gas, and thereby forming cells to give a foam. However, the physical foaming technique causes various environmental disadvantages such that the substance to be used as the blowing agent may be harmful and may deplete ozonosphere. The chemical foaming technique disadvantageously suffers from contamination of a corrosive gas and impurities remaining in the foam after expansion; but such contamination is undesirable particularly in electronic components and other applications where the contamination should be minimized or prevented.

A technique for obtaining a foam having a small cell diameter and a high cell density has been recently proposed. This technique involves dissolving a gas such as nitrogen or carbon dioxide in a polymer under high pressure, subsequently decompressing the polymer (releasing the polymer from the pressure), and heating up the polymer to the vicinity of the glass transition temperature or softening point thereof to form cells. The foaming technique advantageously gives a foam having a micro cell structure, in which nuclei are formed from a thermodynamically unstable state and expand and grow to form cells. In addition, various attempts have been proposed to apply the foaming technique to thermoplastic elastomers such as thermoplastic polyurethanes so as to give flexible foams. Typically, a process is known in which a thermoplastic polyurethane resin is expanded by the foaming technique to give a foam having uniform and micro cells and being resistant to deformation (see Patent Literature 1).

The foaming technique, however, disadvantageously fails to provide a foam with a sufficient expansion ratio. Specifically, according to the foaming technique, the gas (e.g., nitrogen or carbon dioxide) forms nuclei, and the nuclei expand and grow after the release from the pressure (decompression) to reach an atmospheric pressure and form cells in which the gas remains. The foaming technique once gives a foam with a high expansion ratio. However, the gas (e.g., nitrogen or carbon dioxide) remaining in the cells gradually passes through the polymer cell walls, and this causes the foam to contract. The cells thereby gradually deform and/or contract to fail to maintain such a sufficiently high expansion ratio.

In contrast, proposed is a technique of preparing, as a material, a thermoplastic resin composition incorporated with an ultraviolet-curable resin; expanding the resin composition; and curing the ultraviolet-curable resin by forming a crosslinked structure after expansion (see Patent Literature 2).

### CITATION LIST

### Patent Literature

Patent Literature 1: Japanese Unexamined Patent Application Publication (JP-A) No. H10-168215
Patent Literature 2: JP-A No. 2009-13397

### SUMMARY OF INVENTION

### Technical Problem

Such resin foams are more and more used at high temperatures and increasingly require superior strain recoverability even at high temperatures and a high instantaneous recovery rate (instantaneous recoverability from strain). The foam disclosed in Patent Literature 2, however, may be insufficient for these requirements.

Accordingly, an object of the present invention is to provide a resin foam that is satisfactorily flexible, is highly resistant to heat, exhibits superior strain recoverability at high temperatures, and has a high instantaneous recovery rate.

### Solution to Problem

After intensive investigations to achieve the object, the present inventors have found, as a resin composition to form a resin foam, a specific resin composition containing an acrylic polymer, an active-energy-ray-curable compound having two (meth)acryloyl groups per molecule, an active-energy-ray-curable compound having three or more (meth)acryloyl groups per molecule, and a thermal crosslinking agent; and have found that the resin composition can give a resin foam being satisfactorily flexibility and highly resistant to heat, exhibiting excellent strain recoverability at high temperatures, and having a high instantaneous recovery rate. The present invention has been made based on these findings.

Specifically, the present invention provides a resin foam formed from a resin composition, in which the resin composition contains an acrylic polymer; an active-energy-ray-curable compound having two (meth)acryloyl groups per molecule; an active-energy-ray-curable compound having three or more (meth)acryloyl groups per molecule; and a thermal crosslinking agent.

The resin composition preferably contains the active-energy-ray-curable compound having two (meth)acryloyl groups per molecule and the active-energy-ray-curable compound having three or more (meth)acryloyl groups per molecule in a total content of from 20 to 150 parts by weight per 100 parts by weight of the acrylic polymer.

The resin composition preferably contains the thermal crosslinking agent in a content of from 0.2 to 10 parts by weight per 100 parts by weight of the acrylic polymer.

The resin composition preferably further contains a radical scavenger.

The radical scavenger is preferably at least one selected from the group consisting of phenolic antioxidants, phenolic age inhibitors, amine antioxidants, and amine age inhibitors.

The resin composition preferably contains the radical scavenger in a content of from 0.05 to 10 parts by weight per 100 parts by weight of the acrylic polymer.

The resin foam is preferably formed by subjecting the resin composition to expansion molding to give a foamed article; and irradiating the foamed article with an active energy ray.

In addition and advantageously, the present invention provides a process for producing the resin foam. The process includes the steps of: subjecting the resin composition to expansion molding to give a foamed article; and irradiating the foamed article with an active energy ray to give a resin foam.

### Advantageous Effects of Invention

The resin foam according to the present invention is formed from a resin composition containing an acrylic polymer, an active-energy-ray-curable compound having two (meth)acryloyl groups per molecule, an active-energy-ray-curable compound having three or more (meth)acryloyl groups per molecule, and a thermal crosslinking agent. The resin foam is thereby satisfactorily flexible and resistant to heat and exhibits superior strain recoverability at high temperatures.

### BRIEF DESCRIPTION OF DRAWINGS

FIG. 1 is a schematic diagram illustrating a pendulum impact tester.

FIG. 2 is a schematic diagram of an evaluation sample for dynamic dust-proofness evaluation.

FIG. 3 is a schematic cross-sectional view of a dynamic dust-proofness evaluation chamber assembled with the evaluation sample.

FIG. 4 is a schematic cross-sectional view illustrating a tumbler in which the evaluation chamber is placed.

FIG. 5 depict a top view and a cut end view of the evaluation chamber assembled with the evaluation sample.

### DESCRIPTION OF EMBODIMENTS

A resin foam according to an embodiment of the present invention is formed from a resin composition containing an acrylic polymer, an active-energy-ray-curable compound having two (meth)acryloyl groups per molecule, an active-energy-ray-curable compound having three or more (meth)acryloyl groups per molecule, and a thermal crosslinking agent. The “resin composition containing an acrylic polymer, an active-energy-ray-curable compound having two (meth)acryloyl groups per molecule, an active-energy-ray-curable compound having three or more (meth)acryloyl groups per molecule, and a thermal crosslinking agent” is herein also referred to as “resin composition of the present invention.” An “active-energy-ray-curable compound having “n” (meth)acryloyl groups (in a number of “n”) per molecule” is herein also referred to as a “n-functional (meth)acrylate.” Typically, an “active-energy-ray-curable compound having two (meth)acryloyl groups per molecule” is also referred to as a “bifunctional (meth)acrylate”; and an “active-energy-ray-curable compound having three or more (meth)acryloyl groups per molecule” is also referred to as a “trifunctional or higher (meth)acrylate.” As used herein the term “(meth)acryl(ic)” refers to “acryl(ic) and/or methacryl(ic),” and the same is true for other descriptions. Also as used herein the term “(meth)acrylate” refers to “acrylate and/or methacrylate,” and the same is true for other descriptions.

The resin foam according to the present invention is formed by subjecting the resin composition of the present invention to expansion molding. In a preferred embodiment, the resin foam according to the present invention is formed by subjecting the resin composition of the present invention to expansion molding to give a foamed article, and irradiating the foamed article with an active energy ray. In a more preferred embodiment, the resin foam is formed by subjecting the resin composition of the present invention to expansion molding to give a foamed article, irradiating the foamed article with an active energy ray, and further heating the resulting article.

Resin Composition of Present Invention

The resin composition of the present invention contains at least an acrylic polymer, an active-energy-ray-curable compound having two (meth)acryloyl groups per molecule, an active-energy-ray-curable compound having three or more (meth)acryloyl groups per molecule, and a thermal crosslinking agent. The resin composition of the present invention may further contain a thermoplastic resin. The resin composition of the present invention may contain each of different components alone or in combination in respective categories (acrylic polymers, active-energy-ray-curable compounds having two (meth)acryloyl groups per molecule, active-energy-ray-curable compounds having three or more (meth)acryloyl groups per molecule, and thermal crosslinking agents).

The acrylic polymer acts as an essential component in the resin composition of the present invention and is a polymer to constitute the resin foam according to the present invention. The acrylic polymer is preferably a homopolymer or copolymer formed by using an acrylic alkyl ester having an alkyl group (straight chain, branched chain, or cyclic alkyl group) as an essential monomer component. The acrylic polymer preferably has rubber elasticity at room temperature. Each of different acrylic polymers may be contained alone or in combination in the resin composition of the present invention. The “acrylic alkyl ester having an alkyl group” is herein also simply referred to as an “acrylic alkyl ester.”

The resin composition of the present invention may contain the acrylic polymer(s) in a content not critical, but preferably 20 percent by weight or more (e.g., from 20 to 80 percent by weight) and more preferably 30 percent by weight or more (e.g., from 30 to 70 percent by weight) based on the total amount (100 percent by weight) of the resin composition of the present invention.

The acrylic alkyl ester is exemplified by, but not limited to, ethyl acrylate (EA), butyl acrylate (BA), 2-ethylhexyl acrylate (2-EHA), isooctyl acrylate, isononyl acrylate, propyl acrylate, isobutyl acrylate, hexyl acrylate, and isobornyl acrylate (IBXA). Each of different acrylic alkyl esters may be used alone or in combination as the acrylic alkyl ester.

Monomer components to constitute the acrylic polymer may contain the acrylic alkyl ester(s) in a content not critical, but preferably 50 percent by weight or more and more preferably 70 percent by weight or more, based on the total amount (100 percent by weight) of the entire monomer components.

When the acrylic polymer is a copolymer, monomer components to constitute the acrylic polymer include a copolymerizable monomer in addition to the acrylic alkyl ester. The “copolymerizable monomer component” herein is also referred to as an “additional monomer component.” Each of different additional monomer components may be used alone or in combination.

The additional monomer component is preferably a monomer that provides a functional group in the acrylic polymer, which functional group is reactive with a functional group of the thermal crosslinking agent mentioned below. Specifically, the additional monomer component is preferably a monomer that provides a crosslinking point in the acrylic polymer, which crosslinking point acts in crosslinking by the action of the thermal crosslinking agent. The functional group of the acrylic polymer which is reactive with the functional group of the thermal crosslinking agent is herein also referred to as a “reactive functional group.” Of the additional monomer components, the monomer providing, in the acrylic polymer, a functional group acting as a crosslinking point for the thermal crosslinking agent, in other words, the monomer providing a reactive functional group in the acrylic polymer is herein also referred to as a “functional-group-containing monomer.”

In short, the acrylic polymer is preferably a copolymer between the acrylic alkyl ester and the functional-group-containing monomer. The functional-group-containing monomer is exemplified by carboxyl-containing monomers such as methacrylic acid (MAA), acrylic acid (AA), and itaconic acid (IA); hydroxyl-containing monomers such as hydroxyethyl methacrylate (HEMA), 4-hydroxybutyl acrylate (4HBA), and hydroxypropyl methacrylate (HPMA); amino-containing monomers such as dimethylaminoethyl methacrylate (DM); amido-containing monomers such as acrylamide (AM) and methylolacrylamide (N-MAN); epoxy-containing monomers such as glycidyl methacrylate (GMA); acid-anhydride-containing monomers such as maleic anhydride; and cyano-containing monomers such as acrylonitrile (AN). Among them, carboxyl-containing monomers, hydroxyl-containing monomers, and cyano-containing monomers are preferred, of which acrylic acid (AA), 4-hydroxybutyl acrylate (4HBA), and acrylonitrile (AN) are more preferred for easy crosslinking. Each of different functional-group-containing monomers may be used alone or in combination.

The entire monomer components to constitute the acrylic polymer may contain the functional-group-containing monomer(s) in a content not critical, but preferably from 2 to 40 percent by weight, more preferably from 2 to 30 percent by weight, and furthermore preferably from 5 to 20 percent by weight, based on the total amount (100 percent by weight) of the entire monomer components. The range is preferred for obtaining a sufficient crosslinking density and for preventing excessive crosslinking so as to prevent the foam from being less flexible and more hard.

Additional monomer components other than the functional-group-containing monomers are exemplified by vinyl acetate (VAc), styrene (St), methyl methacrylate (MMA), methyl acrylate (MA), and methoxyethyl acrylate (MEA). Among them, methoxyethyl acrylate (MEA) is preferred for superior cold resistance.

The active-energy-ray-curable compound having two (meth)acryloyl groups per molecule (bifunctional (meth)acrylate) is exemplified by, but not limited to, polyethylene glycol di(meth)acrylate, polypropylene glycol di(meth)acrylate, 1,4-butanediol di(meth)acrylate, tetraethylene glycol di(meth)acrylate, 1,6-hexanediol di(meth)acrylate, neopentyl glycol di(meth)acrylate, bisphenol-F-EO-modified di(meth)acrylate, bisphenol-A-EO-modified di(meth)acrylate, and isocyanuric acid-EO-modified di(meth)acrylate. The bifunctional (meth)acrylates may each be a monomer or an oligomer. Each of different bifunctional (meth)acrylates may be used alone or in combination.

The active-energy-ray-curable compound having three or more (meth)acryloyl groups per molecule (trifunctional or higher (meth)acrylate) is exemplified by trimethylolpropane tri(meth)acrylate, pentaerythritol tri(meth)acrylate, tetramethylolmethane tetra(meth)acrylate, pentaerythritol tetra(meth)acrylate, multifunctional polyester acrylates, urethane(meth)acrylates, multifunctional urethane acrylates, epoxy (meth)acrylates, and oligoester (meth)acrylates. Among them, trifunctional (meth)acrylates such as trimethylolpropane tri(meth)acrylate and pentaerythritol tri(meth)acrylate are preferred as the trifunctional or higher (meth)acrylate, for imparting a high elastic modulus to the resin foam to suppress contraction thereof. The trifunctional or higher (meth)acrylates may each be a monomer or an oligomer. Each of different trifunctional or higher (meth)acrylates may be used alone or in combination.

The resin composition of the present invention may contain the bifunctional (meth)acrylate(s) and the trifunctional or higher (meth)acrylate(s) in a total content not critical, but preferably from 20 to 150 parts by weight, more preferably from 30 to 120 parts by weight, and furthermore preferably from 40 to 100 parts by weight, per 100 parts by weight of the acrylic polymer. The resin composition, if containing the two components in a total content of less than 20 parts by weight, may fail to give a resin foam that resists deformation and contraction of its cell structure with time and can maintain a high expansion ratio. In contrast, the resin composition, if containing the two components in a total content of more than 150 parts by weight, may give a resin foam that is excessively hard (rigid) and less flexible.

The ratio of the bifunctional (meth)acrylate to the trifunctional or higher (meth)acrylate in the resin composition of the present invention is not critical, but the ratio (by weight) is preferably from 20:80 to 80:20 and more preferably from 30:70 to 70:30. This range is preferred for good balance between heat resistance and strain recoverability at high temperatures.

The thermal crosslinking agent is exemplified by, but not limited to, isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Each of different crosslinking agents may be used alone or in combination.

Among them, isocyanate crosslinking agents and amine crosslinking agents are preferred as the thermal crosslinking agent, for better heat resistance of the resin foam.

The isocyanate crosslinking agents (multifunctional isocyanate compounds) are exemplified by lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanates, and hydrogenated xylene diisocyanates; and aromatic polyisocyanates such as 2,4-tolylene diisocyanate, 2,6-tolylene diisocyanate, 4,4′-diphenylmethane diisocyanate, and xylylene diisocyanate. The isocyanate crosslinking agents are also exemplified by commercial products such as trimethylolpropane/tolylene diisocyanate adduct [available from Nippon Polyurethane Industry Co., Ltd. under the trade name of “CORONATE L”], trimethylolpropane/hexamethylene diisocyanate adduct [available from Nippon Polyurethane Industry Co., Ltd. under the trade name of “CORONATE HL”], and trimethylolpropane/xylylene diisocyanate adduct [available from Mitsui Chemicals Inc. under the trade name of “TAKENATE D110N”].

The amine crosslinking agents are exemplified by hexamethylenediamine, triethylenetetramine, tetraethylenepentamine, hexamethylenediamine carbamate, N,N′-dicinnamylidene-1,6-hexanediamine, 4,4′-methylenebis(cyclohexylamine) carbamate, and 4,4′-(2-chloroaniline).

The resin composition of the present invention may contain the thermal crosslinking agent(s) in a content not critical, but preferably from 0.01 to 10 parts by weight and more preferably from 0.05 to 5 parts by weight, per 100 parts by weight of the acrylic polymer. The thermal crosslinking agent, if contained in a content of less than 0.01 part by weight, may fail to exhibit sufficient effects in the resin foam according to the present invention. In contrast, the thermal crosslinking agent, if contained in a content of more than 10 parts by weight, may cause the crosslinking reaction to occur excessively and thereby cause the resin foam to be excessively hard and to be less flexible.

The resin composition of the present invention contains the active-energy-ray-curable compounds (bifunctional (meth)acrylate and trifunctional or higher (meth)acrylate) and the thermal crosslinking agent. This helps the resin foam to have better shape retention and to resist deformation and contraction with time when the resin composition of the present invention is subjected to expansion molding and then irradiated with an active energy ray to form a crosslinked structure by the action of the bifunctional (meth)acrylate and trifunctional or higher (meth)acrylate and/or subjected to a heating treatment to form a crosslinked structure by the action of the thermal crosslinking agent. This allows the resin foam to maintain a cell structure with a high expansion ratio, to receive a lower compression load, and to exhibit better flexibility.

The resin composition of the present invention contains the thermal crosslinking agent. This allows crosslinking of the acrylic polymer moiety and helps the resin foam to have better heat resistance when the resin composition of the present invention is subjected to expansion molding and thereafter subjected to a heating treatment to form a crosslinked structure by the action of the thermal crosslinking agent. This also helps the resin foam to have better durability.

In addition, the resin composition of the present invention employs, as active-energy-ray-curable compounds, the bifunctional (meth)acrylate and the trifunctional or higher (meth)acrylate in combination. The bifunctional (meth)acrylate, as used, helps the resin constituting the resin foam according to the present invention to have a lower Tg. This helps the resin foam to resist fixation of a deformed state even when the resin foam is deformed due to an external load. The trifunctional (meth)acrylate, as used, helps the resin foam to have better heat resistance. This allows the resin foam to exhibit strain recoverability at high temperatures and heat resistance both at satisfactory levels. The resin composition, if employing a bifunctional (meth)acrylate alone as the active-energy-ray-curable compound, may fail to help the resin foam to have sufficient heat resistance.

The resin composition of the present invention employs, as active-energy-ray-curable compounds, the bifunctional (meth)acrylate and the trifunctional or higher (meth)acrylate in combination. The trifunctional or higher (meth)acrylate, as used in combination, forms a three-dimensional crosslinked structure and helps the resin foam to have better recoverability from deformation and to also exhibit excellent instantaneous recoverability. As used herein the term “recoverability” refers to a property by which an article tries to return to a state before deformation when the article is deformed due to an external load.

In a preferred embodiment, the resin composition of the present invention further contains a radical scavenger. As used herein the term “radical scavenger” refers to a compound capable of trapping a free radical that causes a radical polymerization reaction. The resin composition of the present invention, when containing a radical scavenger, helps the resin foam to have better working stability upon molding. Though reasons remain unclear, this is probably because as follows. When the resin composition of the present invention is subjected to molding under some conditions, reactions of the active-energy-ray-curable compounds contained as essential components may be accelerated. This is probably because free radicals derived from the acrylic polymer accelerate the curing of the active-energy-ray-curable compounds, which free radicals are formed upon mechanical or thermal cleavage of the molecular chain of the acrylic polymer. The radical scavenger, when contained in the resin composition of the present invention, can suppress such cleavage of the molecular chain and can trap free radicals.

When an after-mentioned inert gas, such as nitrogen or carbon dioxide, is used as a blowing agent in expansion molding of the resin composition of the present invention, there is no inhibitory factor on the radical polymerization reaction, and the free radicals once formed resist inactivation. Also to prevent this, the radical scavenger is preferably contained in the resin composition. The radical scavenger also acts as a thermal stabilizer by trapping free radicals in the resin composition of the present invention.

The radical scavenger is exemplified by, but not limited to, antioxidants and age inhibitors. Each of different radical scavengers may be used alone or in combination.

The antioxidants are exemplified by phenolic antioxidants such as hindered phenolic antioxidants; and amine antioxidants such as hindered amine antioxidants. The hindered phenolic antioxidants are exemplified by pentaerythritol tetrakis[3-(3,5-di-tert-butyl-4-hydroxyphenyl)propionate] (available under the trade name of “Irganox 1010” from BASF Japan Ltd.), octadecyl 3-(3,5-di-tert-butyl-4-hydroxyphenyl)propionate (available under the trade name of “Irganox 1076” from BASF Japan Ltd.), 4,6-bis(dodecylthiomethyl)-o-cresol (available under the trade name of “Irganox 1726” from BASF Japan Ltd.), triethylene glycol bis[3-(3-tert-butyl-5-methyl-4-hydroxyphenyl)propionate] (available under the trade name of “Irganox 245” from BASF Japan Ltd.), bis(2,2,6,6-tetramethyl-4-piperidyl)sebacate (available under the trade name of “TINUVIN 770” from BASF Japan Ltd.), and a polycondensate between dimethyl succinate and 4-hydroxy-2,2,6,6-tetramethyl-1-piperidineethanol (dimethyl succinate-1-(2-hydroxyethyl)-4-hydroxy-2,2,6,6-tetramethylpiperidine polycondensate) (available under the trade name of “TINUVIN 622” from BASF Japan Ltd.). The hindered amine antioxidants are exemplified by bis(1,2,2,6,6-pentamethyl-4-piperidyl) sebacate (methyl) (available under the trade name of “TINUVIN 765” from BASF Japan Ltd.) and bis(1,2,2,6,6-pentamethyl-4-piperidyl)[[3,5-bis(1,1-dimethylethyl)-4-hydroxyphenyl]methyl]butyl malonate (available under the trade name of “TINUVIN 765” from BASF Japan Ltd.).

The age inhibitors are exemplified by phenolic age inhibitors and amine age inhibitors. The phenolic age inhibitors are exemplified by 2-tert-butyl-6-(3-tert-butyl-2-hydroxy-5-methylbenzyl)-4-methylphenyl acrylate (available under the trade name of “SUMILIZER GM” from Sumitomo Chemical Co., Ltd.) and 2-[1-(2-hydroxy-3,5-di-tert-pentylphenyl)ethyl]-4,6-di-tert-pentylphenyl acrylate (available under the trade name of “SUMILIZER GS(F)” from Sumitomo Chemical Co., Ltd.). The amine age inhibitors are exemplified by 4,4′-bis(α,α-dimethylbenzyl)diphenylamine (available under the trade name of “Noclac CD” from Ouchi Shinko Chemical Industrial Co., Ltd.; and under the trade name of “Naugard 445” from Crompton Corporation), N,N′-diphenyl-p-phenylenediamine (available under the trade name of “Noclac DP” from Ouchi Shinko Chemical Industrial Co., Ltd.), and p-(p-toluenesulfonylamido)diphenylamine (available under the trade name of “Noclac TD” from Ouchi Shinko Chemical Industrial Co., Ltd.).

In a preferred embodiment, the radical scavenger is at least one selected from the group consisting of phenolic antioxidants, phenolic age inhibitors, amine antioxidants, and amine age inhibitors, of which the phenolic age inhibitors are more preferred. They are preferred in terms of working stability upon molding and curability upon active energy ray irradiation.

The resin composition of the present invention may contain the radical scavenger(s) in a content not critical, but preferably from 0.05 to 10 parts by weight and more preferably from 0.1 to 10 parts by weight, per 100 parts by weight of the acrylic polymer. The radical scavenger, if contained in a content of less than 0.05 part by weight, may fail to sufficiently trap radicals formed upon molding. In contrast, the radical scavenger, if contained in a content of more than 10 parts by weight, may disadvantageously cause insufficient foaming upon expansion molding of the resin composition or may disadvantageously bleed out to the surface of the produced resin foam.

In another preferred embodiment, the resin composition of the present invention further contains a photoinitiator. This is because the photoinitiator, when contained, facilitates reactions of the bifunctional (meth)acrylate and the trifunctional or higher (meth)acrylate to form a crosslinked structure.

The photoinitiator is exemplified by, but not limited to, benzoin ether photoinitiators such as benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether; acetophenone photoinitiators such as 2,2-diethoxyacetophenone, 2,2-dimethoxy-2-phenylacetophenone, 1-hydroxycyclohexyl phenyl ketone, 4-phenoxydichloroacetophenone, and 4-t-butyl-dichloroacetophenone; α-ketol photoinitiators such as 2-methyl-2-hydroxypropiophenone and 1-[4-(2-hydroxyethyl)-phenyl]-2-hydroxy-2-methylpropan-1-one; aromatic sulfonyl chloride photoinitiators such as 2-naphthalenesulfonyl chloride; photoactive oxime photoinitiators such as 1-phenyl-1,1-propanedione-2-(o-ethoxycarbonyl)-oxime; benzoin photoinitiators such as benzoin; benzil photoinitiators such as benzil; benzophenone photoinitiators such as benzophenone, benzoylbenzoic acid, 3,3′-dimethyl-4-methoxybenzophenone, polyvinylbenzophenones, and α-hydroxycyclohexyl phenyl ketone; ketal photoinitiators such as benzyl dimethyl ketal; thioxanthone photoinitiators such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone; α-amino ketone photoinitiators such as 2-methyl-1-[4-(methylthio)phenyl]-2-morpholinopropan-1-one and 2-benzyl-2-dimethylamino-1-(4-morpholinophenyl)-butanone-1; and acylphosphine oxide photoinitiators such as diphenyl(2,4,6-trimethylbenzoyl)phosphine oxide and bis(2,4,6-trimethylbenzoyl)-phenylphosphine oxide. Each of different photoinitiators may be used alone or in combination.

The resin composition of the present invention may contain the photoinitiator(s) in a content not critical, but preferably from 0.01 to 5 parts by weight and more preferably from 0.2 to 4 parts by weight, per 100 parts by weight of the acrylic polymer.

In yet another preferred embodiment, the resin composition of the present invention further contains powder particles. The powder particles function as a foam-nucleating agent upon expansion molding. The powder particles, when contained in the resin composition of the present invention, may contribute to the production of a resin foam in a good expansion state.

The powder particles for use herein are exemplified by, but not limited to, powdery talc, silica, alumina, zeolite, calcium carbonate, magnesium carbonate, barium sulfate, zinc oxide, titanium oxide, aluminum hydroxide, magnesium hydroxide, mica, montmorillonite and other clay, carbon particles, glass fibers, and carbon tubes. Each of different types of powder particles may be used alone or in combination.

Though not critical, the powder particles have an average particle diameter (particle size) of preferably from 0.1 to 20 μm. The powder particles, if having an average particle diameter of less than 0.1 μm, may fail to sufficiently function as a nucleating agent. In contrast, the powder particles, if having an average particle diameter of more than 20 μm, may cause gas migration (outgassing) upon expansion molding.

The resin composition of the present invention may contain the powder particles in a content not critical, but preferably from 5 to 150 parts by weight and more preferably from 10 to 120 parts by weight, per 100 parts by weight of the acrylic polymer. The powder particles, if contained in a content of less than 5 parts by weight, may fail to contribute to the formation of a resin foam having a uniform cell structure. In contrast, the powder particles, if contained in a content of more than 150 parts by weight, may cause the resin composition to have an excessively high viscosity and may cause gas migration (outgassing) upon expansion molding to impair expansion properties.

In still another preferred embodiment, the resin composition of the present invention further contains a flame retardant. The resin foam according to the present invention is characteristically flammable because of containing a resin. When the resin foam according to the present invention is used in electric/electronic appliances use and other applications where flame-retardancy is to be inevitably imparted, the resin composition preferably contains a flame retardant.

The flame retardant is not limited, but is preferably any of flame-retardant powder particles and other inorganic flame retardants.

The inorganic flame retardants are exemplified by bromine flame retardants, chlorine flame retardants, phosphorus flame retardants, and antimony flame retardants. However, chlorine flame retardants and bromine flame retardants might disadvantageously evolve a gas component upon combustion, which gas component is harmful to the human body and corrosive to appliances; whereas phosphorus flame retardants and antimony flame retardants are disadvantageously harmful or explosive. To prevent these disadvantages, non-halogen non-antimony inorganic flame retardants are preferred as the inorganic flame retardants. The non-halogen non-antimony inorganic flame retardants are exemplified by hydrated metallic compounds such as aluminum hydroxide, magnesium hydroxide, hydrates of magnesium oxide/nickel oxide, and hydrates of magnesium oxide/zinc oxide. The hydrated metal oxides may undergo a surface treatment. Each of different flame retardants may be used alone or in combination.

The resin composition of the present invention may contain the flame retardant(s) in a content not critical, but preferably from 10 to 120 parts by weight per 100 parts by weight of the acrylic polymer so as to give a highly expanded foam while obtaining flame-retarding effects.

Where necessary, the resin composition of the present invention may further contain one or more additives as follows. The additives are exemplified by crystal nucleators, plasticizers, lubricants, colorants (e.g., pigments and dyestuffs), ultraviolet absorbers, fillers, reinforcers, antistatic agents, surfactants, tension modifiers, shrinkage inhibitors, flowability improvers, vulcanizers, coupling agents (surface-treatment agents), and crosslinking coagents.

The resin composition of the present invention may be obtained by mixing and kneading the acrylic polymer, the bifunctional (meth)acrylate, the trifunctional or higher (meth)acrylate, the thermal crosslinking agent, and optional additional components such as the radical scavenger with one another. The mixing and kneading may be performed with heating.

Resin Foam

The resin foam according to the present invention is formed from the resin composition of the present invention. In a preferred embodiment, the resin foam is formed by subjecting the resin composition of the present invention to expansion molding. In a more preferred embodiment, the resin foam is formed by subjecting the resin composition of the present invention to expansion molding to give a foamed article, and irradiating the foamed article with an active energy ray. In a furthermore preferred embodiment, the resin foam is formed by subjecting the resin composition of the present invention to expansion molding to give a foamed article, irradiating the foamed article with an active energy ray, and further heating the resulting article. Specifically, the resin foam according to the present invention is preferably formed by a production process including the steps of subjecting the resin composition of the present invention to expansion molding to give a foamed article; and irradiating the foamed article with an active energy ray to give a resin foam.

In other words, the resin foam according to the present invention is preferably formed by subjecting the resin composition of the present invention to expansion molding to form a foamed structure (cell structure; foamed article), irradiating the foamed structure with an active energy ray to form a crosslinked structure by the action of the bifunctional (meth)acrylate and the trifunctional or higher (meth)acrylate. The resin foam according to the present invention is particularly preferably formed by subjecting the resin composition of the present invention to expansion molding to form a foamed structure, irradiating the foamed structure with an active energy ray to form a crosslinked structure by the action of the bifunctional (meth)acrylate and the trifunctional or higher (meth)acrylate, and further heating the resulting article to form a crosslinked structure by the action of the thermal crosslinking agent. As used herein the term “foamed structure” refers to a foam which is obtained by expansion molding of the resin composition of the present invention, but which has not yet undergone crosslinked structure formation.

A blowing agent of expansion molding of the resin composition of the present invention is not limited, but is preferably one that is a gas at room temperature and normal atmospheric pressure, is inert to the resin composition of the present invention, and with which the resin composition is capable of impregnating. The “one that is a gas at room temperature and normal atmospheric pressure, is inert to the resin composition of the present invention, and with which the resin composition is capable of impregnating” is herein also referred to as an “inert gas.”

The inert gas is exemplified by rare gases (e.g., helium and argon), carbon dioxide, nitrogen, and air. Among them, carbon dioxide or nitrogen is preferred because the resin composition of the present invention can be impregnated with the gas in a satisfactory amount at a satisfactory rate (speed). The inert gas may be a gaseous mixture.

When the inert gas is used as the blowing agent in expansion molding of the resin composition of the present invention, the resin composition preferably contains the radical scavenger, as described above. This is because as follows. Radicals may be formed due to heat or mechanical shearing upon expansion molding of the resin composition. When the inert gas is used, the free radicals once formed resist inactivation because inhibition of the radical polymerization reaction by oxygen does not occur. The formed free radicals might cause specific curing reactions of the active-energy-ray-curable compounds such as the bifunctional (meth)acrylate and the trifunctional or higher (meth)acrylate and, to prevent this, should be trapped.

To speed up the impregnation rate of the resin composition of the present invention with the inert gas, the inert gas is preferably one in a high-pressure state (particularly preferably carbon dioxide gas or nitrogen gas in a high-pressure state) and is more preferably one in a supercritical state (particularly preferably supercritical carbon dioxide gas or supercritical nitrogen gas). In a supercritical state, the gas becomes more soluble in the polymer and can be incorporated into the polymer in a higher concentration. Because of its high concentration upon impregnation as mentioned above, the supercritical gas generates a larger number of cell nuclei upon an abrupt pressure drop (decompression) after impregnation. The cell nuclei grow to form micro cells, which are present in a higher density than in a foam having the same porosity but produced with a gas in another state. Carbon dioxide has a critical temperature and a critical pressure of 31° C. and 7.4 MPa, respectively. Such inert gas in a high-pressure state is herein also referred to as a “high-pressure gas.”

Expansion molding of the resin composition of the present invention, namely, formation of a foamed structure by subjecting the resin composition to expansion molding, may employ a batch system or a continuous system. In the batch system, the resin composition of the present invention is molded or shaped into a suitable shape such as a sheet shape to give an unfoamed resin molded article (unfoamed molded article), the unfoamed resin molded article is impregnated with the high-pressure or supercritical inert gas as a blowing agent and subsequently decompressed to expand the article. In the continuous system, the resin composition of the present invention is kneaded with the inert gas as a blowing agent under pressure (under a load) to give a kneadate, and the kneadate is molded into a molded article and simultaneously decompressed, thus molding and expansion are performed simultaneously.

As is described above, the foamed structure may be prepared by expansion molding through the steps of impregnating the resin composition of the present invention with the blowing agent, and decompressing the resulting article. Typically, the foamed structure may be prepared through the steps of molding the resin composition of the present invention to give an unfoamed resin molded article, impregnating the unfoamed resin molded article with a blowing agent, and decompressing the resulting article to expand the article. The foamed structure may also be prepared by melting the resin composition of the present invention, impregnating the molten resin composition with a blowing agent under pressure, and subjecting the resulting article to molding upon decompression.

A process according to the batch system will be illustrated below.

In the batch system, an unfoamed resin molded article is initially prepared from the resin composition of the present invention. The unfoamed resin molded article may be prepared typically by: a technique of molding the resin composition of the present invention through an extruder such as a single-screw extruder or a twin-screw extruder; a technique of uniformly kneading the resin composition of the present invention using a kneader equipped with one or more blades typically of a roller, cam, kneader, or Banbury type, and press-forming the kneadate typically with a hot-plate press to a predetermined thickness; or a technique of molding the resin composition of the present invention using an injection molding machine.

Next, cells are formed in the unfoamed resin molded article through a gas impregnating step and a decompressing step. In the gas impregnating step, the unfoamed resin molded article is placed in a pressure-tight case (high-pressure case), the inert gas as a blowing agent (of which carbon dioxide or nitrogen is preferred) is injected or introduced into the case, and the unfoamed resin molded article is impregnated with the gas under high pressure. In the decompressing step, at the time when being sufficiently impregnated with the gas, the unfoamed resin molded article is decompressed (generally to an atmospheric pressure) to thereby form cell nuclei therein. Where necessary, the process may further include a heating step of heating the article to grow the cell nuclei.

After growing the cells as above, the resulting article is cooled to fix its shape and thereby yields a foamed structure. Where necessary, the cooling may be performed abruptly typically with chilled water.

The unfoamed resin molded article is not limited in its shape and may be in the form typically of a roll, sheet, or plate. The gas as the blowing agent may be introduced continuously or discontinuously. The heating to grow the cell nuclei may be performed by a known or customary technique typically using a water bath, oil bath, hot roll, hot-air oven, far-infrared rays, near-infrared rays, or microwaves. The unfoamed resin molded article to be expanded may also be prepared by another molding technique than extrusion molding, press forming, and injection molding.

In turn, the continuous system will be illustrated below.

In the continuous system, the resin composition of the present invention is initially subjected to a kneading-impregnating step. In this step, while kneading the resin composition of the present invention using an extruder, the inert gas (of which carbon dioxide or nitrogen is preferred) as a blowing agent is injected or introduced into the extruder to impregnate the resin composition with the gas sufficiently under high pressure.

Next, a kneadate obtained from the kneading-impregnating step is subjected to a molding-decompressing step. In this step, the kneadate is extruded typically through dies installed at the extruder nose, is thereby decompressed (generally to an atmospheric pressure), and thus molding and expansion are performed simultaneously to grow cells. Where necessary, the process may further include a heating step of heating the article to grow the cell nuclei.

After growing the cells as above, the resulting article is cooled to fix its shape and thereby yields a foamed structure. Where necessary, the cooling may be performed abruptly typically with chilled water.

The gas as the blowing agent may be introduced continuously or discontinuously. The heating to grow the cell nuclei may be performed using a technique as in the batch system.

The amount of the inert gas to be incorporated into the resin composition in the gas impregnating step of the batch system or in the kneading-impregnating step of the continuous system is not critical, but is preferably from 1 to 10 percent by weight and more preferably from 2 to 5 percent by weight, relative to the total amount (100 percent by weight) of the resin composition of the present invention or the total amount (100 percent by weight) of the unfoamed resin molded article formed from the resin composition. This range is preferred for obtaining a cell structure with a high expansion ratio.

The pressure upon the inert gas impregnation in the gas impregnating step of the batch system or in the kneading-impregnating step of the continuous system may be suitably selected according to the type of the gas used as the blowing agent and the operability. Typically, carbon dioxide, when used as the inert gas, may be subjected to impregnation at a pressure of preferably 6 MPa or more (e.g., from 6 to 100 MPa) and more preferably 8 MPa or more (e.g., from 8 to 100 MPa). Impregnation with carbon dioxide, if performed at a pressure of less than 6 MPa, may cause excessive or significant cell growth upon expansion to give cells with excessively large diameters. This may readily cause disadvantages such as reduction in dust-proof effects, thus being undesirable. This is because as follows. When impregnation is performed under such a low pressure, the amount of the impregnated carbon dioxide gas is relatively small, and cell nuclei grow at a lower rate as compared to impregnation under a higher pressure. As a result, cell nuclei are formed in a smaller number. This increases, rather than decreases, the gas amount per cell and causes the cells to have excessively large diameters. In addition, in such a low pressure range of less than 6 MPa, only a slight change in impregnation pressure may result in considerable changes in cell diameter and cell density, and this may often impede the control of cell diameter and cell density.

The temperature upon the inert gas impregnation in the gas impregnating step of the batch system or in the kneading-impregnating step of the continuous system may be suitably selected in consideration of the type of the gas to be used as the blowing agent, operability, and the formulation of the resin composition of the present invention. In particular, if the inert gas impregnation is performed at a temperature higher than the reaction initiation temperature of a thermal crosslinking agent contained as an essential component in the resin composition of the present invention, the thermal crosslinking agent acts to form a crosslinked structure, and the crosslinked structure may impede or inhibit the formation of a cell structure with a high expansion ratio. To prevent this, the inert gas impregnation is preferably performed at a temperature lower than the reaction initiation temperature of the thermal crosslinking agent.

The inert gas impregnation may be performed at a temperature of typically from 10° C. to 100° C. In particular, the inert gas impregnation of the unfoamed resin molded article in the batch system may be performed at a temperature of preferably from 10° C. to 80° C. and more preferably from 40° C. to 60° C. The inert gas impregnation of the resin composition in the continuous system may be performed at a temperature of preferably from 10° C. to 100° C. and more preferably from 10° C. to 80° C. When carbon dioxide is used as the inert gas, the impregnation therewith may be performed at a temperature (impregnation temperature) of preferably 32° C. or higher (and more preferably 40° C. or higher) for maintaining its supercritical state.

Though not critical, decompression in the decompressing step and the molding-decompressing step may be performed at a rate of preferably from 5 to 300 MPa per second so as to obtain uniform micro cells. Heating in the heating step may be performed at a temperature of typically from 40° C. to 250° C. and preferably from 60° C. to 250° C.

The process can give a cell structure with a high expansion ratio and can thereby easily produce a thick foamed structure. This is advantageous when the resin foam according to the present invention is to have a large thickness. Typically, when a foamed structure is prepared according to the continuous system, the dies gap (dies clearance) at the extruder nose should be minimized (generally from 0.1 to 1.0 mm) for maintaining the extruder inside pressure during the kneading-impregnating step. To obtain a thick foamed structure, therefore, the resin composition extruded through such a narrow gap should be expanded at a high expansion ratio. According to customary techniques, however, such a high expansion ratio is not obtained, and the resulting foamed structure is limited to thin one (e.g., one having a thickness of from about 0.5 to about 2.0 mm). In contrast, the process employing the inert gas as a blowing agent can continuously give a foamed structure (particularly a sheet-like foamed structure) having a final thickness of from 0.50 to 5.00 mm.

To be such a thick foamed structure, the foamed structure may have a relative density of from 0.02 to 0.3 and more preferably from 0.05 to 0.25. The relative density is the ratio of a density after expansion to a density before expansion. The foamed structure, if having a relative density of more than 0.3, may disadvantageously suffer from insufficient expansion; and if having a relative density of less than 0.02, may disadvantageously have remarkably low strengths.

The foamed structure is not limited typically in its shape and thickness, but is preferably in the form of a sheet having a thickness of from 0.5 to 5 mm. The foamed structure may be processed into a desired shape and thickness before active energy ray irradiation and/or heating for the formation of a crosslinked structure.

The thickness, density, relative density, and other factors of the foamed structure may be regulated according to the formulation of the resin composition of the present invention and the type of the inert gas as a blowing agent. The regulation is performed by suitably selecting: temperature, pressure, time, and other operational conditions in the gas impregnating step or kneading-impregnating step; decompression rate, temperature, pressure, and other operational conditions in the decompressing step or molding-decompressing step; and heating temperature in the heating step performed after the decompressing or molding-decompressing.

The crosslinked structure formation by the action of the bifunctional (meth)acrylate and the trifunctional or higher (meth)acrylate may be performed by active energy ray irradiation. The active energy ray is exemplified by alpha rays, beta rays, gamma rays, neutron beams, electron beams, and other ionizing radiation; and ultraviolet rays. In terms of workability, ultraviolet rays and electron beams are preferred; of which electron beams are more preferred so as to form a crosslinked structure sufficiently. Typically, to form a crosslinked structure in a black foamed structure, electron beams are preferably employed. The active energy ray irradiation is not limited typically in energy, time, and procedure.

The active energy ray irradiation of the foamed structure may be performed in any manner not limited. For example, when the foamed structure is in the form of a sheet and to be irradiated with an ultraviolet ray as the active energy ray, the sheet-like foamed structure may be irradiated with the ultraviolet ray on one side up to 750 mJ/cm²; and then irradiated with the ultraviolet ray on the other side up to 750 mJ/cm². When the foamed structure is in the form of a sheet and to be irradiated with electron beams as the active energy ray, the sheet-like foamed structure may be irradiated with the electron beams to a dose of from 50 to 300 kGy.

The heating treatment allows the thermal crosslinking agent to form a crosslinked structure. The heating treatment is not limited, but exemplified by a heating treatment of leaving the article stand at an ambient temperature of from 100° C. to 220° C. (preferably from 110° C. to 180° C., and furthermore preferably from 120° C. to 170° C.) for a duration of from 10 minutes to 10 hours (preferably from 30 minutes to 8 hours, and furthermore preferably from one hour to 5 hours). The ambient temperature as above can be obtained by a known heating procedure such as heating with an electric heater, heating with electromagnetic waves such as infrared rays, and heating on a water bath.

The resin foam according to the present invention may have any cell structure, but preferably has a closed cell structure or a semi-open semi-closed cell structure. The term “semi-open semi-closed (cell) structure” refers to a cell structure including both a closed cell structure and an open cell structure in coexistence. The semi-open semi-closed structure may include a closed cell structure in any percentage not critical. In particular, the resin foam according to the present invention has a cell structure including a closed cell structure moiety in a percentage of preferably 80% or more (and more preferably 90% or more).

The resin foam according to the present invention may have an average cell diameter of the cell structure (cellular structure) not critical, but preferably from 10 to 200 μm and more preferably from 10 to 150 μm. The resin foam, when controlled to have an average cell diameter of 200 μm or less in terms of upper limit, can have better dust-proofness and exhibit good light-blocking effect. The resin foam, when controlled to have an average cell diameter of 10 μm or more in terms of lower limit, can have good flexibility.

The resin foam according to the present invention, when having a cell structure (cellular structure) with an average cell diameter of 200 μm or less, excels in dust-proofness, particularly in dynamic dust-proofness, even when having a small thickness (e.g., 0.5 mm or less).

The cell structure and average cell diameter of the resin foam according to the present invention may be determined typically by cutting the resin foam, capturing an image of a cross-sectional cell structure of the cut resin foam using a digital microscope, and analyzing the image.

The resin foam according to the present invention may have a density not critical, but preferably from 0.01 to 0.8 g/cm³ and more preferably from 0.02 to 0.2 g/cm³. The resin foam, when having a density within the range, can have suitable strengths and flexibility and readily develops superior cushioning properties and superior recoverability (recoverability from a deformed state).

The resin foam according to the present invention may have any thickness and shape that are not critical and are selected suitably according to the intended use. Preferably, the resin foam according to the present invention is in the form of a sheet, tape, or film. The resin foam according to the present invention has a thickness of preferably from 0.1 to 20 mm and more preferably from 0.2 to 15 mm. The resin foam according to the present invention may undergo a processing such as punching or die cutting so as to have a desired thickness and shape.

The resin foam according to the present invention may have a compression load upon 50% compression not critical, but preferably from 0.1 to 5.0 N/cm², more preferably from 0.1 to 3.0 N/cm², and furthermore preferably from 0.1 to 2.0 N/cm², in terms of dust-proofness and flexibility. The term “compression load upon 50% compression” refers to a load necessary for the resin foam to be compressed by 50% of the initial thickness. The compression load upon 50% compression may be determined according to the compressive hardness measuring method described in JIS K 6767.

The resin foam according to the present invention may have an after-defined thickness recovery rate (23° C., one minute, 50% compression) not critical, but preferably 70% or more and more preferably 80% or more in terms of dust-proofness, particularly of dynamic dust-proofness (dust-proofness in a dynamic environment). The resin foam, when having a thickness recovery rate (23° C., one minute, 50% compression) of 70% or more, may exhibit excellent instantaneous recoverability (instantaneous recoverability from a deformed state). The resin foam, when having a high thickness recovery rate (23° C., one minute, 50% compression), may exhibit excellent dust-proofness. Specifically, assume that this resin foam is applied typically to a cabinet; and that the resin foam is deformed by the action of external force to cause space between the resin foam and the cabinet. Even in this case, the resin foam can immediately recover from the deformed state and is restored to a state before deformation.

The “thickness recovery rate (23° C., one minute, 50% compression)” is specified as a value determined by compressing the resin foam at 23° C. by 50% of its initial thickness, holding the resin foam in the compressed state at 23° C. for one minute, decompressing the resin foam, measuring a thickness one second after the decompression, and calculating, as the thickness recovery rate, the percentage of the measured thickness to the initial thickness.

The resin foam according to the present invention may have an after-defined strain recovery rate (80° C., 24 hours, 50% compression) not critical, but preferably 80% or more and more preferably 85% or more in terms of sealability and dust-proofness at high temperatures.

The “strain recovery rate (80° C., 24 hours, 50% compression)” is herein specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, decompressing the resin foam, determining a compressed distance and a recovered distance, and calculating, as the strain recovery rate, a percentage of the recovered distance with respect to the compressed distance.

The resin foam according to the present invention may have an after-defined variation in impact absorption rate not critical, but preferably 5% or less and more preferably 3% or less. The resin foam according to the present invention, when having a variation in impact absorption rate of 5% or less, can highly thermally stably absorb impact and is stably usable not only at room temperature, but also at high ambient temperatures (e.g., from 60° C. to 200° C.)

The “variation in impact absorption rate” is herein defined as an absolute value of a difference in impact absorption rate (%) between two specimens of the resin foam, where one specimen undergoes compression at 23° C. for 5 minutes by 50% of an initial thickness thereof and subsequent decompression (released from the decompressed state), and the other specimen undergoes compression at 180° C. for 5 minutes by 50% of an initial thickness thereof and subsequent decompression. The impact absorption rate (%) is determined according to an expression as follows:

Impact absorption rate (%)=(F0−F1)/F0×100

where:

F0 represents a value as determined by preparing a laminate including a supporting plate and an acrylic plate, bringing a steel ball into collision with the acrylic plate side of the laminate, measuring an impact force received by the supporting plate, and defining the measured impact force as F0; and

F1 represents a value as determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1.

The variation in impact absorption rate is defined as an absolute value of a difference in impact absorption rate (%) between two specimens of the resin foam, where one specimen undergoes compression at 23° C. for 5 minutes by 50% of an initial thickness thereof and subsequent decompression, and the other specimen undergoes compression at 180° C. for 5 minutes by 50% of an initial thickness thereof and subsequent decompression.

The resin foam according to the present invention may have a rate of dimensional change not critical, but preferably 10% or less and more preferably 5% or less, after left stand at 200° C. for one hour. The resin foam according to the present invention, when having a rate of dimensional change of 5% or less, is highly thermally stable and is stably usable not only at room temperature, but also at high ambient temperatures (e.g., from 60° C. to 200° C.)

The “rate of dimensional change” refers to a value determined by preparing a 100-mm wide, 100-mm long, and 1-mm thick sheet-like specimen from the resin foam, measuring rates of dimensional change in the crosswise direction, longitudinal direction (machine direction), and thickness direction, respectively, and defining a highest rate of dimensional change among the rates of dimensional change in these directions as the “rate of dimensional change.” Typically, “when the rate of dimensional change is 10% or less,” it means that all the rates of dimensional change in the crosswise direction, machine direction, and thickness direction in the specimen are 10% or less. The rate of dimensional change (%) may be determined according to an expression as follows:

Rate of dimensional change (%)=(L0−L1)/L0×100

where:

L0 represents the initial specimen's dimension (blank value); and

L1 represents the specimen's dimension after left stand at 200° C. for one hour.

The resin foam according to the present invention may have any rate of weight change, but preferably 15% or less and more preferably 5% or less, after left stand at 200° C. for one hour. The resin foam according to the present invention, when having a rate of weight change of 15% or less, is highly thermally stable and is stably usable not only at room temperature, but also at high ambient temperatures (e.g., from 60° C. to 200° C.)

The rate of weight change (%) may be determined according to an expression as follows:

Rate of weight change (%)=(W0−W1)/W0×100

where:

W0 represents the initial specimen's weight (blank value); and

W1 represents the specimen's weight after left stand at 200° C. for one hour.

The resin foam according to the present invention may have a total luminous transmittance not critical, but preferably 10% or less and more preferably 3% or less. The resin foam, when having a total luminous transmittance of 10% or less, is preferably usable in applications requiring light blocking. The term “total luminous transmittance” refers to a total luminous transmittance of a 0.6-mm thick sheet specimen prepared from the resin foam, as determined according to JIS K 7136.

The resin foam according to the present invention may have a degree of blackness L* not critical, but preferably less than 50, more preferably less than 45, and furthermore preferably less than 40. The degree of blackness L* is one of characteristics of a color and refers to the degree of lightness of the color. With an increasing degree of blackness L*, the color has higher lightness. The color is white when L* is 100; and the color is black when L* is 0. With an increasing degree of blackness, the resin foam has a decreasing total luminous transmittance and exhibits better blocking effect.

As is described above, the resin foam according to the present invention is formed from the resin composition of the present invention, thereby resists deformation and contraction with time, maintains its cell structure with a high expansion ratio, has excellent flexibility, and exhibits superior heat resistance. The resin foam is therefore highly stable and exhibit excellent workability and impact absorption even at high ambient temperatures of higher than 200° C.

In addition, the resin foam according to the present invention excels in strain recoverability and instantaneous recoverability at high temperatures (e.g., from 60° C. to 200° C., and particularly from 60° C. to 120° C.). The resin foam therefore excels in dust-proofness, particularly in dynamic dust-proofness. In addition, the resin foam excels in dust-proofness, particularly in dynamic dust-proofness, even at high ambient temperatures. Furthermore, the resin foam excels in sealability and exhibits superior sealability even at high ambient temperatures.

The resin foam according to the present invention is preferably used typically for or as internal insulators in electronic appliances and other articles, cushioning materials, sound insulators, heat insulators, food packaging materials, clothing materials, and building materials.

### EXAMPLES

The present invention will be illustrated in further detail with reference to several examples below, which are by no means intended to limit the scope of the invention.

### Example 1

A resin composition was obtained by charging materials into a two-bladed compact 10-L dispersion kneader (supplied by Toshin Co., Ltd.) and kneading them at a temperature of 80° C. for 40 minutes. The materials were 100 parts by weight of an acrylic elastomer, 30 parts by weight of a bisphenol-A-EO-modified diacrylate (supplied under the trade name of “NK Ester A-BPE30” by Shin-Nakamura Chemical Co., Ltd., an ethoxylated bisphenol-A diacrylate), 45 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E.I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

The resin composition was charged into a single-screw extruder. At a temperature of 60° C., while kneading the resin composition, carbon dioxide gas was injected (introduced) into the single-screw extruder in such a gas amount as to be 4 percent by weight relative to the total amount (100 percent by weight) of the resin composition at a fed gas pressure of 28 MPa. These were sufficiently mixed and kneaded so as to impregnate the resin composition sufficiently with the carbon dioxide gas.

Next, the resin composition was extruded through a circular die provided at the single-screw extruder nose into the atmosphere, thereby decompressed to the atmospheric pressure, expanded through simultaneous molding and expansion, and yielded a sheet-like foamed structure.

This step corresponds to the molding-decompressing step and includes extruding the resin composition from the single-screw extruder and decompressing the same to the atmospheric pressure to perform molding and expansion simultaneously to thereby allow the resin composition to expand.

Both sides of the above-obtained sheet-like foamed structure were irradiated with electron beams at an acceleration voltage of 250 kV to a dose of 200 kGy to form a crosslinked structure. After the electron beam irradiation, the resulting article was further subjected to a heating treatment by leaving the same stand at an ambient temperature of 170° C. for one hour to further form a crosslinked structure.

Thus, a sheet-like resin foam was obtained.

### Example 2

A resin composition was obtained by the procedure of Example 1 and charged into a single-screw extruder; and carbon dioxide gas was injected (introduced) into the single-screw extruder in such a gas amount as to be 3.2 percent by weight relative to the total amount (100 percent by weight) of the resin composition. Molding and expansion were performed simultaneously by the procedure of Example 1 and yielded a sheet-like foamed structure.

Next, the sheet-like foamed structure was irradiated with electron beams by the procedure of Example 1 to form a crosslinked structure. The resulting article was further subjected to a heating treatment by leaving the same stand at an ambient temperature of 210° C. for 5 minutes to further form a crosslinked structure.

Thus, a sheet-like resin foam was obtained.

### Example 3

A resin composition was obtained by the procedure of Example 1 and charged into a single-screw extruder; and carbon dioxide gas was injected (introduced) into the single-screw extruder in such a gas amount as to be 3.3 percent by weight relative to the total amount (100 percent by weight) of the resin composition. Molding and expansion were performed simultaneously by the procedure of Example 1 and yielded a sheet-like foamed structure.

Next, the sheet-like foamed structure was irradiated with electron beams by the procedure of Example 1 to form a crosslinked structure. The resulting article was further subjected to a heating treatment by leaving the same stand at an ambient temperature of 210° C. for 5 minutes to further form a crosslinked structure.

Thus, a sheet-like resin foam was obtained.

### Example 4

A resin composition was obtained by charging materials into a two-bladed compact 10-L dispersion kneader (supplied by Toshin Co., Ltd.) and kneading them at a temperature of 80° C. for 40 minutes. The materials were 100 parts by weight of an acrylic elastomer, 45 parts by weight of a polypropylene glycol diacrylate (supplied under the trade name of “ARONIX M-270” from Toagosei Co., Ltd.), 30 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E.I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

A sheet-like resin foam was obtained from the above-obtained resin composition by the procedure of Example 1.

### Comparative Example 1

A resin composition was obtained by charging materials into a twin-screw kneader, thoroughly kneading them at a temperature of 200° C., extruding the kneadate into strands, cooling the strands with water, and cutting and shaping the cooled strands into pellets. The materials were 50 parts by weight of a thermoplastic elastomer composition, 50 parts by weight of a polypropylene, 10 parts by weight of a lubricant composition, and 50 parts by weight of magnesium hydroxide as a nucleating agent. The thermoplastic elastomer composition was a blend (TPO) of a polypropylene (PP) with an ethylene/propylene/5-ethylidene-2-norbornene ternary copolymer (EPT) and further included carbon black.

The pelletized resin composition was charged into a single-screw extruder, and carbon dioxide gas was injected into the single-screw extruder at an ambient temperature of 220° C. and a pressure of 25 MPa while kneading the resin composition. After being sufficiently saturated with the carbon dioxide gas, the resin composition was extruded through a die provided at the single-screw extruder nose, thereby decompressed to the atmospheric pressure, expanded through simultaneous molding and expansion, and yielded a sheet-like resin foam.

### Comparative Example 2

A commercially available (sheet-like) resin foam including a polyurethane as a principal component was used.

### Comparative Example 3

A resin composition was obtained by charging materials into a two-bladed compact 10-L dispersion kneader (supplied by Toshin Co., Ltd.) and kneading them at a temperature of 80° C. for 40 minutes. The materials were 100 parts by weight of an acrylic elastomer, 75 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E.I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

A sheet-like resin foam was prepared from the above-obtained resin composition by the procedure of Example 1.

Evaluations

The resin foams obtained in the examples and comparative examples were subjected to measurements and evaluations as follows. The results are indicated in Tables 1 and 2.

Thickness (Initial Thickness)

The thickness (initial thickness) (μm) of each resin foam was measured with a 1/100-scale dial gauge having a measuring terminal 20 mm in diameter.

Density (Apparent Density)

Each resin foam was subjected to blanking (die cutting) to give a 20-mm wide and 20-mm long specimen. The specific gravity of the specimen was measured with an electronic densimeter (supplied under the trade name of “MD-200S” by Alfa Mirage Co., Ltd.), from which the density (g/cm³) of the specimen was determined.

Average Cell Diameter

The average cell diameter (μm) of each resin foam was determined in a manner as follows.

The average cell diameter was determined with a digital microscope (supplied under the trade name of “VHX-600” by Keyence Corporation) by capturing an image of a cell-structure region of the resin foam cross section, measuring areas of all cells appearing in a predetermined area (1 mm²) of the cross cut section, converting the measured areas into equivalent circle diameters, and summing up and averaging the diameters by the number of cells.

The image analysis was performed with an image analyzing software (supplied under the trade name of “WIN ROOF” by Mitani Corporation).

Compression Load upon 50% Compression (50% Compression Load, Compressive Hardness upon 50% Compression)

The compression load upon 50% compression was determined by measuring the same according to the compressive hardness measuring method described in JIS K 6767.

Specifically, each resin foam was cut to give 1-mm thick, 20-mm diameter round specimens. Next, at an ambient temperature of 23° C., the specimens were compressed in a thickness direction to a thickness of 50% of the initial thickness and held in the compressed state for 20 seconds. The specimens were subsequently decompressed, loads (N) were measured 20 seconds after the decompression, the measured loads were converted into values per unit area (1 cm²), and the values were each defined as the compression load upon 50% compression (N/cm²).

The compression load upon 50% compression was determined on two specimens per one resin foam, i.e., a specimen after aging at 23° C., and a specimen after the aging and subsequently leaving stand in an oven at 200° C. for one hour. In Table 1, the “compression load upon 50% compression of the specimen after aging at 23° C.” is indicated in “before heating” of “compression load upon 50% compression”; whereas the “compression load upon 50% compression of the specimen after the aging and subsequent leaving stand in an oven at 200° C. for one hour” is indicated in after heating” of “compression load upon 50% compression.”

Thickness Recovery Rate (23° C., One Minute, 50% Compression))

Each resin foam was cut to give a 1-mm thick, 25-mm square sheet-like specimen.

The thickness recovery rate (23° C., one minute, 50% compression) was measured in a manner as follows. Using an electromagnetic force micro material tester (Micro-Servo) (“MMT-250” supplied by Shimadzu Corporation), the specimen was compressed in a thickness direction to a thickness of 50% of the initial thickness at an ambient temperature of 23° C., and held in the compressed state at 23° C. for one minute. After decompressing the specimen, pictures of a thickness recovery behavior (thickness change, thickness recovery) were taken by a high-speed camera, and the thickness one second after the decompression was determined from the taken pictures. The thickness recovery rate (23° C., one minute, 50% compression) (%) was determined according to an equation as follows:

Thickness recovery rate (23° C.,one minute,50% compression)=(Thickness one second after the decompression)/(Initial thickness)×100

Strain Recovery Rate (80° C., 24 Hours, 50% Compression)

Each resin foam was cut to give a 1-mm thick, 25-mm square sheet-like specimen.

The specimen was compressed to 50% of the initial thickness using a spacer, and the specimen was stored in this state (compressed state) at 80° C. for 24 hours. Twenty-four (24) hours later, the specimen was returned to 23° C. while being held in the compressed state and subsequently decompressed. The thickness of the specimen was accurately measured 24 hours after the decompression.

The ratio of the recovered distance to the compressed distance was determined according to an expression and defined as the strain recovery rate (80° C., 24 hours, 50% compression) (%), where the expression is expressed as follows:

Strain recovery rate (80° C.,24 hours,50% compression)(%)=(c−b)/(a−b)×100

where:

“a” represents the specimen's thickness;

“b” represents a thickness half the specimen's thickness; and

“c” represents the specimen's thickness after decompression.

Variation in Impact Absorption Rate

Each resin foam was cut to give two 1-mm thick, 20-mm square sheet-like specimens.

At an ambient temperature of 23° C., one of the specimens was compressed in a thickness direction to a thickness of 50% of the initial thickness and held in the compressed state for 5 minutes. The specimen was subsequently decompressed and yielded Specimen A. The impact absorption rate of Specimen A was determined by an impact absorption rate measuring method as mentioned below.

Next, at an ambient temperature of 180° C., the other of the specimens was compressed in a thickness direction to a thickness of 50% of the initial thickness and held in the compressed state for 5 minutes. The specimen was subsequently decompressed and yielded Specimen B. The impact absorption rate of Specimen B was determined by the impact absorption rate measuring method.

An absolute value of the difference in impact absorption rate between Specimen A and Specimen B was defined as the variation in impact absorption rate.

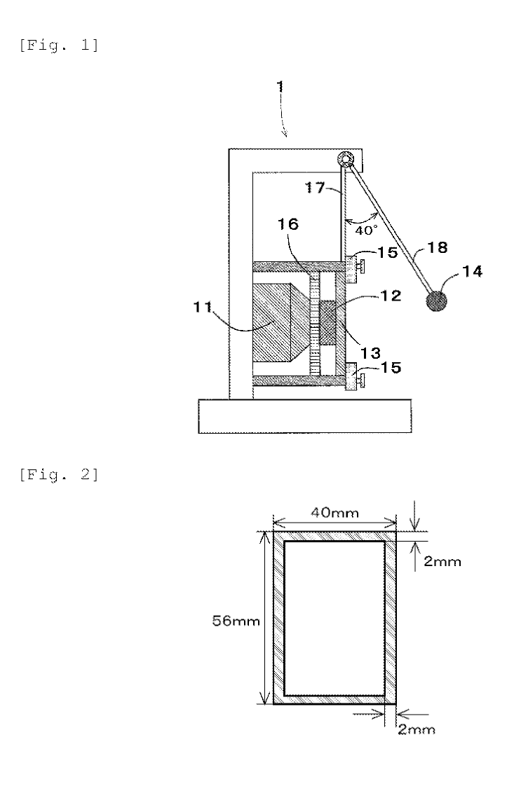

The impact absorption rate (%) of each specimen was determined in a manner as follows. Using a pendulum impact tester illustrated in FIG. 1, an impact force where no specimen was inserted (impact force of the supporting plate and the acrylic plate alone) (blank value) was measured as F0; whereas an impact force where the specimen was inserted into between the supporting plate and the acrylic plate was measured as F1; and the impact absorption rate (%) was determined according to an equation as follows:

Impact absorption rate (%)=(F0−F1)/F0×100

FIG. 1 is a schematic diagram illustrating the pendulum impact tester where the specimen is inserted. In FIG. 1, reference signs 1 stands for the pendulum impact tester; 11 stands for a load cell; 12 stands for the specimen; 13 stands for the acrylic plate; 14 stands for the iron ball; 15 stands for a pressing-force controller; 16 stands for the supporting plate; 17 stands for a supporting shaft; and 18 stands for a pendulum arm. The load cell 11 has a pressure sensor sensing an impact force upon collision of the iron ball 14 and can measure a specific value of impact force. As illustrated in FIG. 1, the specimen 12 was placed between the acrylic plate 13 and the supporting plate 16 at a position corresponding to the load cell. The pressing-force controller 15 controlled the compression rate of the specimen 12. The iron ball 14 acted as an impactor and had a diameter of 19.5 mm and a weight of 40-gram weight (0.39 N). The iron ball 14 was raised to and once fixed at a dropping angle (rise angle) of 40°, and then dropped.

Rate of Dimensional Change

Each resin foam was cut to give an about 100-mm square sheet-like specimen. Dimensions of the specimen in the machine direction (MD), crosswise direction (CD; transverse direction (TD)), and thickness direction were measured respectively using digital vernier calipers.

Next, the specimen was left stand in an oven at 200° C. for one hour. One hour later, the specimen was retrieved from the oven, and dimensions of the specimen in the machine direction, crosswise direction, and thickness direction were measured respectively by the above procedure.

The rates of dimensional change in the machine direction, crosswise direction, and thickness direction were respectively calculated according to an expression as follows:

Rate of dimensional change (%)=(L0−L1)/L0×100

where:

L0 represents the initial specimen's dimension (blank value); and

L1 represents the specimen's dimension after left stand at 200° C. for one hour.

Rate of Weight Change

Each resin foam was cut to give a 1-mm thick, 100-mm square sheet-like specimen. The weight of the specimen was measured using an electronic balance.

Next, the specimen was left stand in an oven at 200° C. for one hour. One hour later, the specimen was retrieved from the oven, and the weight thereof was measured using the electronic balance by the above procedure.

Based on these data, the rate of weight change was calculated according to an equation as follows:

Rate of weight change (%)=(W0−W1)/W0×100

where:

W0 represents the initial specimen's weight (blank value); and

W1 represents the specimen's weight after left stand at 200° C. for one hour.

Total Luminous Transmittance

A 30-mm square, 0.6-mm thick sheet-like specimen was obtained from each resin foam.

The total luminous transmittance of the specimen was measured according to JIS K 7361 using a haze meter (supplied under the trade name of “HM-150” by Murakami Color Research Laboratory).

Degree of Blackness

A 1-mm thick sheet-like specimen was obtained from each resin foam.

The degree of blackness of the specimen was measured using a handy spectrophotometric type color difference meter (supplied under the device name of “NF333” by Nippon Denshoku Industries Co., Ltd.).

Dynamic Dust-Proofness

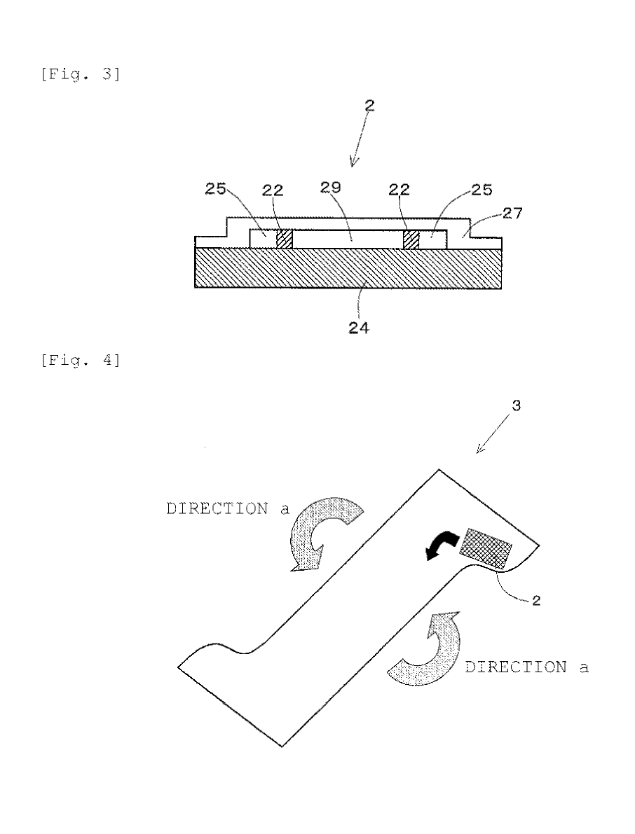

Each resin foam was punched to give a frame-like evaluation sample (see FIG. 2) and, with reference to FIGS. 3 and 5, assembled to an evaluation chamber (dynamic dust-proofness evaluation chamber mentioned below; see FIGS. 3 and 5). Next, particulate matter was fed to outside of the evaluation sample (powder-supply area) in the evaluation chamber, and the evaluation chamber to which the particulate matter was fed was placed in a tumbler (tumbling barrel), the tumbler was rotated counterclockwise to load impact to the evaluation chamber repeatedly.

FIG. 3 is a simple schematic cross-sectional view of the dynamic dust-proofness evaluation chamber assembled with the evaluation sample. In FIG. 3, reference signs 2 stands for the evaluation chamber assembled with the evaluation sample (package assembled with the evaluation sample); 22 stands for the evaluation sample (resin foam punched into a frame); 24 stands for a base plate; 25 stands for the powder-supply area; 27 stands for a foam-compressing board; and 29 stands for an internal space of the evaluation chamber (the inside of the package). In the evaluation chamber assembled with the evaluation sample illustrated in FIG. 3, the powder-supply area 25 and the evaluation chamber internal space 29 are partitioned from each other by the evaluation sample 22; and the powder-supply area 25 and the evaluation chamber internal space 29 form closed systems, respectively.

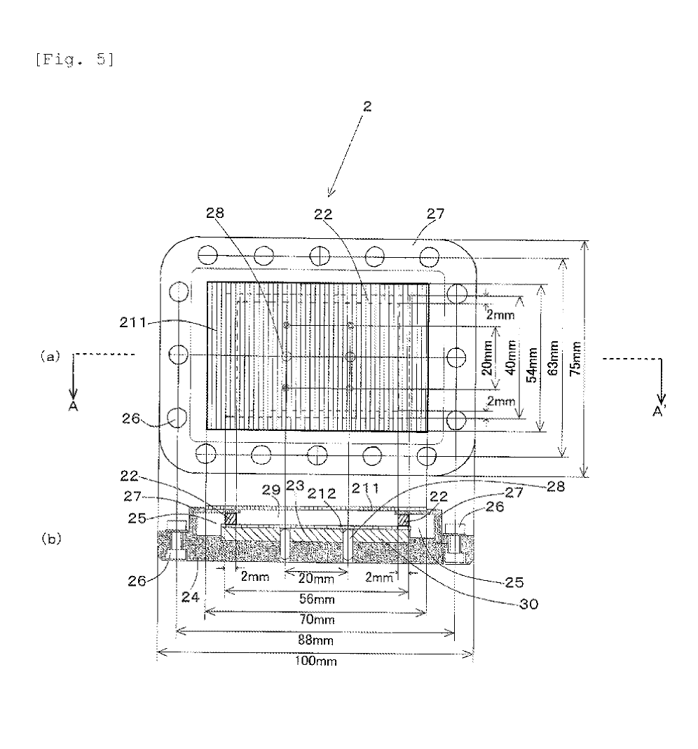

FIG. 4 is a schematic cross-sectional view illustrating the tumbler in which the evaluation chamber is placed. In FIG. 4, reference signs 3 stands for the tumbler; 2 stands for the evaluation chamber assembled with the evaluation sample; and direction “a” stands for the tumbler rotating direction. The rotation of the tumbler 3 loaded impact to the evaluation chamber 2 repeatedly.

How to evaluate the dynamic dust-proofness will be illustrated in further detail below.

Each resin foam was punched to give a frame-like (window-frame-like) evaluation sample with a frame width of 2 mm as illustrated in FIG. 1.

With reference to FIGS. 3 and 5, the evaluation sample was installed onto an evaluation chamber (dynamic dust-proofness evaluation chamber; see FIGS. 3 and 5). When installed, the evaluation sample was compressed at a compression rate of 50% (compressed to 50% of the initial thickness).

With reference to FIG. 5, the evaluation sample was placed between the foam-compressing board and a black acrylic plate arranged over the aluminum plate that was fixed to the base plate. In the evaluation chamber installed with the evaluation sample, the evaluation sample formed a closed system in a predetermined area of the inside of the chamber.

With reference to FIG. 5, after installing the evaluation sample to the evaluation chamber, 0.1 g of corn starch (particle size: 17 μm) as dust particles was placed in the powder-supply area, and the evaluation chamber was placed in a tumbler (tumbling barrel, drum drop tester), and the tumbler was rotated at a rate of 1 rpm.

After the tumbler was rotated predetermined times so as to give 100 collisions (repeated impacts), the package was disassembled. Particles which passed from the powder-supply area through the evaluation sample and were deposited on the black acrylic plate over the aluminum plate and on the black acrylic plate serving as a cover plate were observed with a digital microscope (supplied under the device name of “VHX-600” by Keyence Corporation). Static images of the black acrylic plate facing the aluminum plate and of the black acrylic plate serving as the cover plate were made and binarized using an image analyzing software (supplied under the software name of “Win ROOF” by Mitani Corporation) to measure a total area of particles. The total area of particles was divided by a particle area (area per one particle) to calculate a particle number. The observation was performed in a clean bench so as to reduce the influence of airborne dust.

A total particle number herein was calculated as the total sum of the number of particles deposited on the black acrylic plate facing the aluminum plate and the number of particles deposited on the black acrylic plate serving as the cover plate. A sample having a total particle number of 50×10⁴ or less was evaluated as having good dynamic dust-proofness, whereas one having a total particle number of more than 50×10⁴ was evaluated as having poor dynamic dust proofness.

FIG. 5 depict a top view and a cut end view of the evaluation chamber (dynamic dust-proofness evaluation chamber) assembled with the evaluation sample. FIGS. 5(a) and 5(b) depict a top view and a cut end view along line A-A′, respectively, of the dynamic dust-proofness evaluation chamber assembled with the evaluation sample. The dynamic dust-proofness (dust-proofness upon impact) of the evaluation sample can be evaluated by assembling the evaluation sample to the evaluation chamber and dropping the evaluation chamber. In FIG. 5, reference signs 2 stands for the evaluation chamber assembled with the evaluation sample; 211 stands for the black acrylic plate (black acrylic plate serving as the cover plate); 212 stands for the black acrylic plate (black acrylic plate facing the aluminum plate); 22 stands for the evaluation sample (frame-like resin foam); 23 stands for the aluminum plate; 24 stands for the base plate; 25 stands for the powder-supply area; 26 stands for a screw; 27 stands for the foam-compressing board; 28 stands for a pin; 29 stands for the evaluation chamber internal space; and 30 stands for the aluminum spacer. The compression rate of the evaluation sample 22 can be controlled by adjusting the thickness of the aluminum spacer 30. In the dynamic dust-proofness evaluation chamber assembled with the evaluation sample, a cover-plate-fixing bracket was provided between screws facing each other and firmly fixed the black acrylic plate 211 to the foam-compressing board 27; although the fixing bracket is not shown in the top view FIG. 5(a).

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Thickness (mm) | | 1 | 1 | 1 | 1 | 1 | 1 | 1 |
| Average cell diameter (μm) | | 144 | 137 | 195 | 166 | 100 | 70-80 | 371 |
| Density (g/cm³) | | 0.078 | 0.083 | 0.068 | 0.12 | 0.05 | 0.15 | 0.051 |
| Compression load | Before heating | 0.7 | 1.27 | 0.8 | 0.4 | 1.55 | 1.0 | 0.45 |
| upon 50% | After heating | — | 2.10 | — | — | Incompressible | — | — |
| compression (N/cm²) | | | | | | | | |
| Thickness recovery rate | | 85 | 76 | 81 | 70< | 93 | 65 | 70< |
| (23° C., one minute, 50% compression) (%) | | | | | | | | |
| Strain recovery rate | | 92 | 94 | 90 | 89 | 0 | 99 | 80< |
| (80° C., 24 hrs, 50% compression) (%) | | | | | | | | |
| Variation in impact absorption rate (%) | | 0.3 | 0.0 | 0.7 | 0-1 | 26.5 | 5.8 | 0-1 |
| Total luminous (% transmittance) | | 0 | 0 | 0 | 0 | 0 | 0 | 10< |
| Dynamic dust- | Total particle | 125890 | 150570 | 230576 | — | 330461 | 100 × 10⁴< | 100 × 10⁴< |
| proofness | number | | | | | | | |
| | Evaluation | Good | Good | Good | — | Good | Poor | Poor |

| | | | | | | | |
|---|---|---|---|---|---|---|---|
| Degree of blackness L* | 24.21 | 20.91 | 22.26 | — | — | 26.45 | 23.90 |

In Table 1, the symbol “—” indicates that no measurement was performed.

A sample, when having a compression load upon 50% compression of less than 2.5 N/cm², can be evaluated as having a superior cushioning function. The specimen after heating of Comparative Example 1 was immeasurable on the compression load upon 50% compression, because the specimen could not be compressed to 50% of the initial thickness. The specimen of Comparative Example 1 could be evaluated as losing flexibility due to heating.

TABLE 2

| | | | | Rate of dimensional change | | | | | | | | |
|---|---|---|---|---|---|---|---|---|---|---|---|---|
| | Rate of weight change | | | MD | | | TD | | | Thickness direction | | |
| | W0 | W1 | Rate of | L0 | L1 | Rate of | L0 | L1 | Rate of | L0 | L1 | Rate of |
| | (g) | (g) | change (%) | (mm) | (mm) | change (%) | (mm) | (mm) | change (%) | (mm) | (mm) | change (%) |
| Example 2 | 0.79 | 0.78 | 1.54 | 100.00 | 100.00 | 0.00 | 100.00 | 100.00 | 0.00 | 0.88 | 0.87 | 1.70 |
| Comparative | 0.61 | 0.50 | 17.50 | 100.00 | 36.50 | 63.50 | 100.00 | 34.40 | 65.80 | 1.24 | 0.06 | 95.39 |
| Example 1 | | | | | | | | | | | | |
| Comparative | 0.68 | 0.65 | 3.77 | 100.00 | 98.90 | 1.10 | 100.00 | 98.90 | 1.10 | 2.25 | 2.24 | 0.44 |
| Example 3 | | | | | | | | | | | | |

### INDUSTRIAL APPLICABILITY

The resin foam according to the present invention is usable typically for or as internal insulators in electronic appliances and other articles, cushioning materials, sound insulators, heat insulators, food packaging materials, clothing materials, and building materials.

### REFERENCE SIGNS LIST

11 load cell
12 specimen
13 acrylic plate
14 iron ball
15 pressing-force controller
16 supporting plate
17 supporting shaft
18 pendulum arm
3 tumbler
2 evaluation chamber assembled with evaluation sample
211 black acrylic plate
212 black acrylic plate
22 evaluation sample
23 aluminum plate
24 base plate
25 powder-supply area
26 screw
27 foam-compressing board
28 pin
29 evaluation chamber internal space
30 aluminum spacer

1. A resin foam formed from a resin composition, the resin composition comprising: an acrylic polymer; an active-energy-ray-curable compound having two (meth)acryloyl groups per molecule; an active-energy-ray-curable compound having three or more (meth)acryloyl groups per molecule; and a thermal crosslinking agent.

2. The resin foam according to claim 1, wherein the resin composition comprises the active-energy-ray-curable compound having two (meth)acryloyl groups per molecule and the active-energy-ray-curable compound having three or more (meth)acryloyl groups per molecule in a total content of from 20 to 150 parts by weight per 100 parts by weight of the acrylic polymer.

3. The resin foam according to claim 1, wherein the resin composition comprises the thermal crosslinking agent in a content of from 0.2 to 10 parts by weight per 100 parts by weight of the acrylic polymer.

4. The resin foam according to claim 1, wherein the resin composition further comprises a radical scavenger.

5. The resin foam according to claim 4, wherein the radical scavenger is at least one selected from the group consisting of phenolic antioxidants, phenolic age inhibitors, amine antioxidants, and amine age inhibitors.

6. The resin foam according to claim 4, wherein the resin composition comprises the radical scavenger in a content of from 0.05 to 10 parts by weight per 100 parts by weight of the acrylic polymer.

7. The resin foam according to claim 1, which is formed by subjecting the resin composition to expansion molding to give a foamed article; and irradiating the foamed article with an active energy ray.

8. A process for producing the resin foam of claim 1, the process comprising the steps of: subjecting the resin composition to expansion molding to give a foamed article; and irradiating the foamed article with an active energy ray to give a resin foam.
